(19) United States
(12) Patent Application Publication
(10) Pub. No.: US 2025/0102311 A1
(43) Pub. Date: Mar. 27, 2025

(54) HYBRID ELECTRIC VEHICLE

(71) Applicant: TOYOTA JIDOSHA KABUSHIKI KAISHA, Toyota-shi (JP)

(72) Inventor: Yuki YAMADA, Toyota-shi (JP)

(73) Assignee: TOYOTA JIDOSHA KABUSHIKI KAISHA, Toyota-shi (JP)

(21) Appl. No.: 18/641,763

(22) Filed: Apr. 22, 2024

(30) Foreign Application Priority Data
Sep. 27, 2023 (JP) 2023-165217

(51) Int. Cl. G01C 21/34; B60W 30/182; B60W 50/00; B60W 50/14; G01C 21/36

(52) U.S. Cl. CPC G01C 21/3469; B60W 30/182; B60W 50/14; G01C 21/3461; G01C 21/3617; G01C 21/367; B60W 2050/0083; B60W 2050/146; B60W 2556/40

(57) ABSTRACT

A control device of a hybrid electric vehicle executes a traveling assist control to travel based on a traveling assist plan in which a motor traveling mode or an ordinary traveling mode is assigned to each traveling section of a traveling route planned or estimated based on map information and the position of the hybrid electric vehicle, using information about each traveling section. Further, the control device creates the traveling assist plan based on a motor traveling level that has a plurality of stages and that is set to each traveling section.

### CROSS-REFERENCE TO RELATED APPLICATION

This application claims priority to Japanese Patent Application No. 2023-165217 filed on Sep. 27, 2023, incorporated herein by reference in its entirety.

### BACKGROUND

### 1. Technical Field

The present disclosure relates to a hybrid electric vehicle.

### 2. Description of Related Art

Conventionally, as this kind of hybrid electric vehicle, there has been proposed a hybrid electric vehicle in which switching is performed among modes: an electric motor mode for traveling using only an electric motor; an engine mode for traveling using only an engine; and a combination-use mode in which both the electric motor and the engine are used in combination, depending on mode-switching vehicle speed (refer to Japanese Unexamined Patent Application Publication No. 06-187595, for example). This hybrid electric vehicle switches the mode-switching vehicle speed for each of various environments such as an urban area, a suburban area, an expressway, and a tunnel, and thereby, allows traveling suitable for the environment.

### SUMMARY

In recent years, a motor-traveling-limited region where only motor traveling is permitted, as exemplified by a zero emission zone (ZEZ) where the emission of exhaust gas is prohibited, a motor-traveling-recommended region such as a low emission zone (LEZ) where the emission of exhaust gas is restrained as much as possible, and the like are set, and it is desirable that traveling is performed depending on each region. Further, for restraining noise, a user sometimes wants to set a motor traveling region to the periphery of the home, or the like. When the motor traveling is uniformly performed in each region, the remaining capacity of the battery decreases before the arrival at the motor-traveling-limited region, and the motor traveling cannot be performed in the motor-traveling-limited region, in some cases.

A hybrid electric vehicle in the present disclosure has a main object to allow the motor traveling to be more accurately performed in a region where the motor traveling is particularly necessary.

The hybrid electric vehicle in the present disclosure adopts the following means for achieving the above-described main object.

A hybrid electric vehicle includes:
an engine that is capable of outputting dynamic power for traveling;
a motor that is capable of outputting dynamic power for traveling;
an electricity storage device that is capable of exchanging electric power with the motor; and
a control device that executes a traveling assist control to travel based on a traveling assist plan, when the engine and the motor are controlled with switching between a motor traveling mode and an ordinary traveling mode, the motor traveling mode being a mode of performing motor traveling in which the hybrid electric vehicle travels by the dynamic power from the motor in a state where operation of the engine is stopped, the ordinary traveling mode being a mode of performing ordinary traveling in which the hybrid electric vehicle travels by the dynamic power from the engine and the dynamic power from the motor as necessary, the traveling assist plan being a plan in which the motor traveling mode or the ordinary traveling mode is assigned to each traveling section of a traveling route using information about each traveling section, the traveling route being planned or estimated based on map information and the position of the hybrid electric vehicle, in which
the control device creates the traveling assist plan based on a motor traveling level set to each traveling section, the motor traveling level having a plurality of stages.

The hybrid electric vehicle in the present disclosure includes the engine that is capable of outputting the dynamic power for traveling, the motor that is capable of outputting the dynamic power for traveling, the electricity storage device that is capable of exchanging electric power with the motor, and the control device that controls the engine and the motor with the switching between the motor traveling mode of performing the motor traveling in which the hybrid electric vehicle travels by the dynamic power from the motor in the state where the operation of the engine is stopped and the ordinary traveling mode of performing the ordinary traveling in which the hybrid electric vehicle travels by the dynamic power from the engine and the dynamic power from the motor as necessary. Using the information about each traveling section of the traveling route planned or estimated based on the map information and the position of the hybrid electric vehicle, the control device executes the traveling assist control to travel based on the traveling assist plan in which the motor traveling mode or the ordinary traveling mode is assigned to each traveling section. The control device creates the traveling assist plan based on the motor traveling level that has the plurality of stages and that is set to each traveling section of the planned or estimated traveling route. That is, the motor traveling mode is assigned in the order from the traveling section that has the highest motor traveling level among the planned or estimated traveling sections. Thereby, it is possible to more accurately assign the motor traveling mode to the traveling section that has a high motor traveling level, and to more accurately perform the motor traveling. The “planned traveling route” means a traveling route that is set by a route guidance from a current place to a destination, and the “estimated traveling route” means a traveling route that is estimated for the traveling from the current place.

In the hybrid electric vehicle in the present disclosure, the control device may charge the electricity storage device before traveling in a traveling section in which the motor traveling level is a predetermined level or higher. Thereby, it is possible to more accurately perform the motor traveling in the traveling section in which the motor traveling level is the predetermined level or higher. When the motor traveling can be performed in the traveling section in which the motor traveling level is the predetermined level or higher even if the electricity storage device is not charged a predetermined distance before the targeted traveling section, the electricity storage device does not need to be charged. Thereby, it is possible to avoid the electricity storage device from being needlessly charged.

In the hybrid electric vehicle in the present disclosure, the control device may create the traveling assist plan such that the motor traveling mode is set preferentially to a user setting traveling section that is set on the traveling route by a user as a section in which the motor traveling needs to be performed. Thereby, it is possible to more accurately reflect the intention of the user. In this case, the control device may create the traveling assist plan such that the motor traveling mode is set preferentially to an institution setting traveling section that is set on the traveling route by a public institution as a section in which the motor traveling needs to be performed. Furthermore, in this case, the control device may create the traveling assist plan such that the motor traveling mode is set preferentially to a section that is set at a predetermined strength or higher by the public institution as the institution setting traveling section in which the motor traveling needs to be performed, over a user setting traveling section. As an example in which the motor traveling level is used, this case corresponds to a case where the motor traveling level at first to fourth stages that are of five strength stages decided by the public institution and at which the degree of the motor is low is set to 3, the motor traveling level at a fifth stage at which the strength is highest is set to 5, and the motor traveling level of the user setting traveling section is set to 4.

In the hybrid electric vehicle in the present disclosure, the control device may create the traveling assist plan such that the motor traveling mode is set preferentially to a traveling section to home, when a spot set by a user as the home is planned or estimated to be a destination, and may create the traveling assist plan based on the motor traveling level of a traveling section that includes the home, when the home is a passing spot to the destination. That is, in the case where the user returns to the home, the motor traveling mode is set preferentially to the traveling section to the home, and in the case where the user passes through the home and then goes to the destination, the traveling mode is set depending on the motor traveling level that is previously decided for the traveling section that includes the home. Thereby, it is possible to more properly cope with the case where the user returns to the home and the case where the user passes through the home.

The hybrid electric vehicle in the present disclosure may include a display device that displays the position of the hybrid electric vehicle and at least a part of the traveling route together with the map information, in which the control device performs such a control that the display is performed on the display device by a display method based on the motor traveling level. Thereby, it is possible to display the motor traveling level on the display device by using different display methods, and it is possible to cause the user to easily recognize the motor traveling level in each region. As the display method, a color for each motor traveling level can be used, or luminance or brightness for each motor traveling level can be used.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing an example of a hybrid electric vehicle 20 in an embodiment of the present disclosure as a block with a focus on a hybrid ECU 50;

FIG. 2 is a flowchart showing an example of a traveling assist control that is executed by the hybrid ECU 50;

FIG. 3 is an explanatory diagram showing an example of a motor traveling level;

FIG. 4 is an explanatory diagram showing an example in which map information about the vicinity of the current position is displayed on a display device 66 using a display method depending on the motor traveling level; and

FIG. 5 is a flowchart showing an example of a process that is executed by the hybrid ECU 50 before traveling in a high motor traveling level section.

### DETAILED DESCRIPTION OF EMBODIMENTS

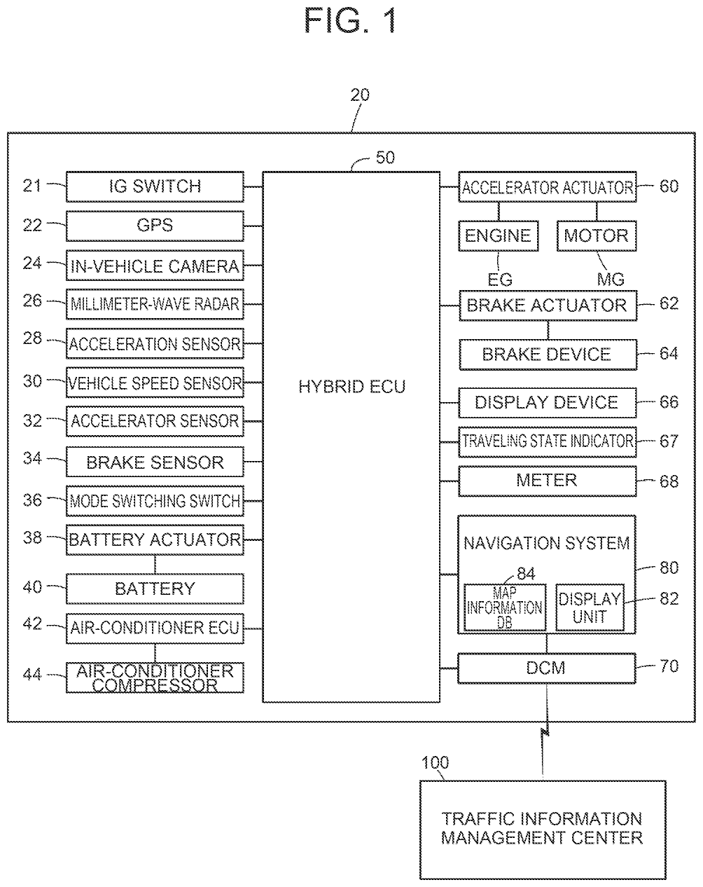

Next, a mode (embodiment) for carrying out the present disclosure will be described. FIG. 1 is a block diagram showing an example of a hybrid electric vehicle 20 in an embodiment of the present disclosure as a block with a focus on a hybrid electronic control unit (referred to as a hybrid ECU, hereinafter) 50. As illustrated, the hybrid electric vehicle 20 in the embodiment includes an engine EG and a motor MG as dynamic power sources. As traveling modes, the hybrid electric vehicle 20 in the embodiment has a motor traveling mode of traveling by the dynamic power from the motor MG in a state where the operation of the engine EG is stopped and an ordinary traveling mode of traveling by the dynamic power from the engine EG and the dynamic power from the motor MG while the engine EG is operated as necessary. The ordinary traveling mode includes a charge depleting mode (CD mode) of prioritizing electric traveling such that a state-of-charge SOC of a battery 40 is decreased and a charge sustaining mode (CS mode) of using both electric traveling and hybrid traveling such that the state-of-charge SOC of the battery 40 is maintained at a target ratio.

In addition to the dynamic power sources, the hybrid electric vehicle 20 in the embodiment includes an ignition switch 21, a global positioning system (global positioning satellite, GPS) 22, an in-vehicle camera 24, a millimeter-wave radar 26, an acceleration sensor 28, a vehicle speed sensor 30, an accelerator sensor 32, a brake sensor 34, a mode switching switch 36, a battery actuator 38, a battery 40, an air-conditioner electronic control unit (referred to as an air-conditioner ECU, hereinafter) 42, an air-conditioner compressor 44, the hybrid ECU 50, an accelerator actuator 60, a brake actuator 62, a brake device 64, a display device 66, a traveling state indicator 67, a meter 68, a data communication module (DCM) 70, a navigation system 80, and the like.

The GPS 22 is a device that detects the position of the vehicle based on signals that are sent from a plurality of GPS satellites. The in-vehicle camera 24 is a camera that images the periphery of the vehicle, and includes a forward camera that images a vehicle forward view and a rearward camera that images a vehicle rearward view, for example. The millimeter-wave radar 26 detects the inter-vehicle distance and relative speed between an own vehicle and a leading vehicle, and detects the inter-vehicle distance and relative speed between the own vehicle and a following vehicle.

For example, the acceleration sensor 28 is a sensor that detects the acceleration of the vehicle in the front-rear direction of the vehicle and detects the acceleration of the vehicle in the right-left direction (lateral direction) of the vehicle. The vehicle speed sensor 30 detects the vehicle speed of the vehicle based on a wheel speed or the like. The accelerator sensor 32 detects an accelerator operation amount corresponding to the stepping amount of an accelerator pedal by a driver, or the like. The brake sensor 34 detects a brake position as the stepping amount of a brake pedal by the driver, or the like. The mode switching switch 36 is a switch that is disposed near a steering wheel at a driver's seat and that performs the switching between the motor traveling mode and the ordinary traveling mode.

The battery actuator 38 detects the state of the battery 40, for example, an inter-terminal voltage, a charge-discharge current, and a battery temperature, and manages the battery 40 based on the inter-terminal voltage, the charge-discharge current, and the battery temperature. The battery actuator 38 computes the state-of-charge SOC that is the ratio of a remaining electricity storage capacity to a full electricity storage capacity, based on the charge-discharge current, and computes a maximal allowable output electric power (output limit Wout) that may be output from the battery 40 and a maximal allowable input electric power (input limit Win) that may be input to the battery 40, based on the state-of-charge SOC and the battery temperature. The battery 40 is configured as a secondary battery that allows charge and discharge, and for example, a lithium-ion battery, a nickel-hydrogen battery, a lead storage battery, or the like can be used.

The air-conditioner ECU 42 is configured as a microcomputer that mainly includes an unillustrated CPU, and includes a ROM, a RAM, a flash memory, an input port, an output port, a communication port, and the like, in addition to the CPU. The air-conditioner ECU 42 is built in an air-conditioning device that performs air conditioning in an occupant compartment, and drives and controls the air-conditioner compressor 44 in the air-conditioning device such that the temperature of the occupant compartment becomes a set temperature.

The engine EG is configured as an internal combustion engine, for example. The motor MG is configured as an electric motor that has also the function of an electric generator, for example, as a synchronous generator-motor. The motor MG, which is connected to the battery 40 through an unillustrated inverter, can output drive force using the electric power supplied from the battery 40, and can charge the battery 40 by the generated electric power.

The hybrid ECU 50 is configured as a microcomputer that mainly includes an unillustrated CPU, and includes a ROM, a RAM, a flash memory, an input port, an output port, a communication port, and the like, in addition to the CPU. The hybrid ECU 50 sets the traveling mode, and sets a target operation point (target rotation speed or target torque) of the engine EG and a torque command of the motor MG, based on the set traveling mode, the accelerator operation amount from the accelerator sensor 32, the brake position from the brake sensor 34, and the output limit and input limit from the battery actuator 38. The hybrid ECU 50 is not activated in the state of accessory-on, and is activated in the state of ready-on.

When motor traveling is performed, the hybrid ECU 50 sets a required drive force or required power, based on the accelerator operation amount from the accelerator sensor 32 and the vehicle speed from the vehicle speed sensor 30, sets the torque command of the motor MG such that the required drive force or required power is output to the vehicle, and sends the set torque command to the accelerator actuator 60. When a hybrid traveling is performed, the hybrid ECU 50 sets the target operation point of the engine EG and the torque command of the motor MG such that the required drive force or required power is output to the vehicle, and sends the target operation point and the torque command to the accelerator actuator 60. Further, when the brake pedal is stepped on, the hybrid ECU 50 sets a required braking force based on the brake position from the brake sensor 34 and the vehicle speed from the vehicle speed sensor 30, sets a torque command for regeneration such that the regenerative control of the motor MG is performed based on the required braking force and the vehicle speed, and sets a target braking force by the brake device. The hybrid ECU 50 sends the torque command to the accelerator actuator 60, and sends the target braking force to the brake actuator 62.

The accelerator actuator 60 drives and controls the engine EG and the motor MG based on the target operation point and torque command set by the hybrid ECU 50. The accelerator actuator 60 performs an intake air amount control, a fuel injection control, an ignition control, an air intake valve opening-closing timing control, and the like, such that the engine EG operates at the target operation point (target rotation speed or target torque). Further, the accelerator actuator 60 performs a switching control of a switching element that is included in an inverter for driving the motor MG, such that a torque corresponding to the torque command is output from the motor MG.

The brake actuator 62 controls the brake device 64, such that the target braking force set by the hybrid ECU 50 is applied to the vehicle by the brake device 64. The brake device 64 is configured as a hydraulically driven friction brake, for example.

The display device 66 is built in an instrument panel in front of the driver's seat, for example. The display device 66 displays a variety of information, and functions also as a touch panel. The traveling state indicator 67 includes an unillustrated EV indicator and HV indicator. When the motor traveling is performed, the traveling state indicator 67 turns on the EV indicator and turns off the HV indicator, and when the hybrid traveling is performed, the traveling state indicator 67 turns off the EV indicator and turns on the HV indicator. The meter 68 is built in the instrument panel in front of the driver's seat, for example.

The data communication module (DCM) 70 sends information about the own vehicle to a traffic information management center 100, and receives road traffic information from the traffic information management center 100. Examples of the information about the own vehicle include the position, vehicle speed, traveling power, and traveling mode of the own vehicle. Examples of the road traffic information can include information relevant to a current or future congestion, a current average vehicle speed in each traveling section on a traveling route or a predicted value of a future average vehicle speed in each traveling section, information relevant to traffic regulation, information relevant to weather, information relevant to road surface condition, and information relevant to a map. The DCM 70 communicates with the traffic information management center 100 at predetermined intervals (for example, at intervals of 30 seconds, 1 minute, 2 minutes, or the like). The traveling section is basically set as the range between intersections, and when the range between intersections is long, the traveling section is set as a range of a predetermined distance.

The navigation system 80 is a system that guides the own vehicle to a set destination, and includes a display unit 82 and a map information database 84. The display unit 82 is a functional block that has a function to display a route to the destination, the position of the own vehicle, and the like on the display device 66 based on the map information. The navigation system 80 communicates with the traffic information management center 100 through the data communication module (DCM) 70. When a destination or passing place is set, the navigation system 80 sets a route based on information about the destination or passing place, information about the current place (the current position of the own vehicle) that is acquired by the GPS 22, and information stored in the map information database 84. Then, the navigation system 80 communicates with the traffic information management center 100 at predetermined intervals (for example, at intervals of 3 minutes, 5 minutes, or the like), to acquire the road traffic information, and performs route guidance based on the road traffic information. The map information stored in the map information database 84 includes not only map data but also a road gradient, road type, altitude, motor traveling level and others for each traveling section. The motor traveling level is the degree (strength) of the motor traveling, and in the embodiment, for a motor traveling level EVL, eight stages from an EVL0 at which the regulation is not performed to an EVL7 at which only the motor traveling is permitted are used.

When the route guidance is performed, the navigation system 80 generates information about the load necessary to travel in each traveling section, or the like, as look-ahead information, based on information about each traveling section of the traveling route, information relevant to traveling load, the vehicle speed of the own vehicle, the traveling power of the own vehicle, the traveling mode of the own vehicle, and the like that are included in the road traffic information acquired from the traffic information management center 100, every time the road traffic information is acquired from the traffic information management center 100 (or every predetermined time), and sends the look-ahead information to the hybrid ECU 50. The look-ahead information includes the information about the own vehicle, as exemplified by the position, vehicle speed, traveling power, traveling mode and others of the own vehicle, the information relevant to the current or future congestion, the information relevant to the current average vehicle speed in the section of the traveling route or the predicted value of the future average vehicle speed, the information relevant to the traffic regulation, the information relevant to the weather, the information relevant to the road surface condition, the information relevant to the map, and the like. The information relevant to the map includes a region (motor traveling region) where the motor traveling needs to be performed and that is decided by a public institution such as a nation, a city, a town, or a village, the strength (the level for the motor traveling that is decided by the public institution) of the motor traveling, and the like. The navigation system 80 can set the motor traveling region, based on user's operation designating a region such as a region in the vicinity of the home. The navigation system 80 sends a signal indicating whether the own vehicle is traveling in the motor traveling region, to the hybrid ECU 50.

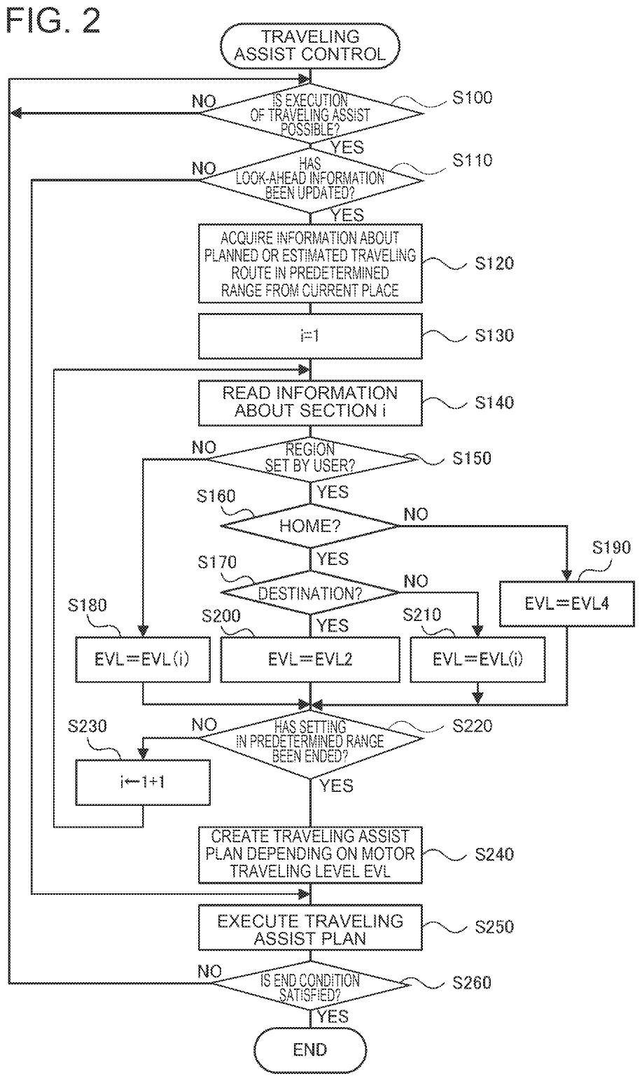

Next, the operation of the hybrid electric vehicle 20 configured in this way, particularly, the operation when the hybrid electric vehicle 20 creates a traveling assist plan depending on the motor traveling level and travels in accordance with the created traveling assist plan will be described. FIG. 2 is a flowchart showing an example of a traveling assist control that is executed by the hybrid ECU 50. This flowchart is executed after the ignition switch 21 is turned on.

In the traveling assist control, first, it is determined whether the execution of the traveling assist control is possible (step S100). The execution of the traveling assist control is not possible, when the route guidance cannot be appropriately performed, for example, when an abnormality has occurred in the navigation system 80 or when an abnormality has occurred in the GPS 22. When the battery temperature is low, the output limit Wout that is the maximal allowable output electric power that may be output from the battery 40 becomes small, and the engine EG is frequently started even in the case of the traveling in the CD mode, so that the traveling in the CD mode cannot be properly performed. Due to such a circumstance, in step S100, it is determined whether the execution of the traveling assist control is possible. When it is determined in step S100 that the execution of the traveling assist control is not possible, the hybrid ECU 50 waits until the execution of the traveling assist control becomes possible.

When it is determined in step S100 that the execution of the traveling assist control is possible, it is determined whether the look-ahead information sent from the navigation system 80 has been updated (step S110). When it is determined that the look-ahead information has been updated, information about the planned or estimated traveling route in a predetermined range from the current place is acquired (step S120). As the predetermined range, 5 km, 10 km, 15 km or the like can be used. The planned traveling route is a traveling route that is planned by the navigation system 80 as the route guidance from the current place to the destination when the destination is set, and the estimated traveling route is a traveling route that is estimated for the traveling from the current place.

Subsequently, a section variable i for repetition is initialized to a value “1” (step S130), and processes of steps S140 to S230 are repeated for setting the motor traveling level EVL for all traveling sections of the traveling route in the acquired information.

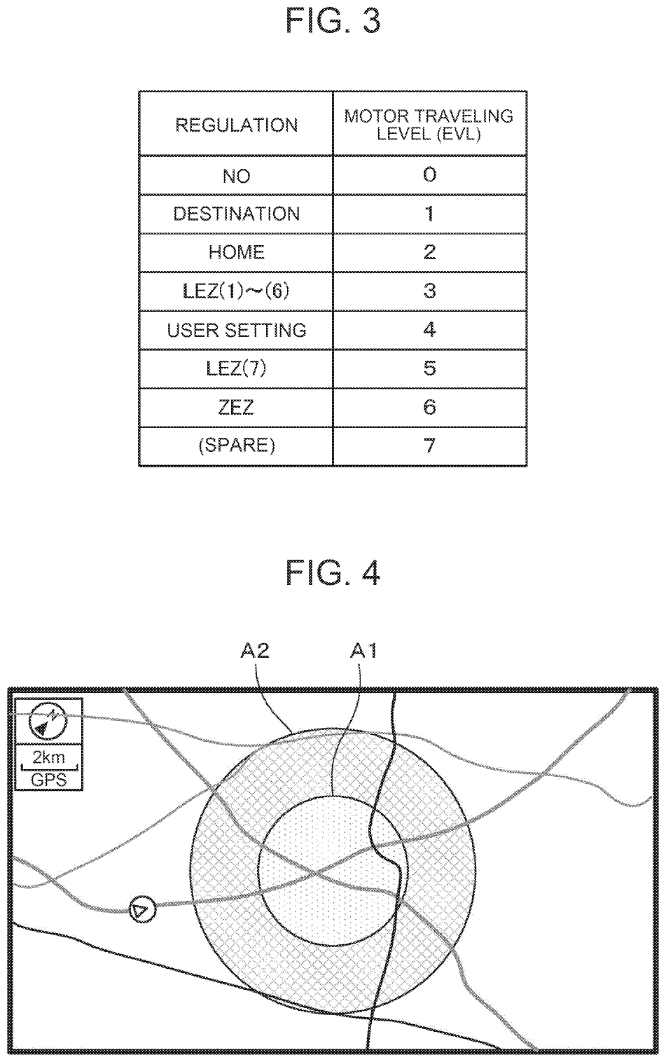

In the repetition process, first, the information about the traveling section for the section variable i is read (step S140), and it is determined whether the targeted traveling section (i) has been set by the user as the region (motor traveling region) where the motor traveling needs to be performed (step S150). When it is determined that the targeted traveling section (i) has not been set by the user as the motor traveling region, the motor traveling level EVL of the targeted traveling section (i) is set depending on the strength of the motor traveling that is set for the targeted traveling section (i) by the public institution or the like (step S180). FIG. 3 shows an example of the degree of the regulation and the motor traveling level EVL. In FIG. 3, “LEZ” is a low emission zone (LEZ), and means a region shown where the motor traveling with the degree (strength) shown by one of values “1” to “7” decided by the public institution or the like is recommended. “ZEZ” is a zero emission zone (ZEZ), and means a region where only the motor traveling is permitted by the public institution or the like. In the embodiment, the motor traveling level EVL3 is set for the LEZ (1) to the LEZ (6), the motor traveling level EVL5 is set for the LEZ (7), and the motor traveling level EVL6 is set for the ZEZ. The motor traveling level EVL4 is set for the motor traveling region set by the user. The reason why the motor traveling level EVL of the motor traveling region set by the user is set so as to be higher than the motor traveling level EVL3 for the LEZ (1) to the LEZ (6) is because the intention of the user is more accurately reflected, and the reason why the motor traveling level EVL of the motor traveling region set by the user is set so as to be lower than the motor traveling level EVL5 for the LEZ (7) is because it is thought that the intention of the user does not exceed the highest order of the motor traveling recommendation by the public institution. “NO” in the regulation means a region for which the strength of the motor traveling has not been set by the public institution and that is not the motor traveling region set by the user, and in the embodiment, the motor traveling level EVL0 is set.

When it is determined in step S150 that the targeted traveling section (i) is the motor traveling region set by the user, it is determined whether the home is included in the targeted traveling section (i) (step S160). When it is determined that the home is not included in the targeted traveling section (i), it is determined that the targeted traveling section (i) is the motor traveling region set by the user, and in the embodiment, the motor traveling level EVL4 is set for the traveling section (i) (see FIG. 3).

When it is determined in step S160 that the home is included in the targeted traveling section (i), it is determined whether the home is the destination (step S170). This determination can be performed based on whether the home has been set as the destination or whether the home is estimated to be the destination. That is, when the route guidance from the current place to the destination is being performed by the navigation system 80, the determination is performed based on whether the home has been set as the destination. When the route guidance is not being performed by the navigation system 80, the determination is performed based on whether the vehicle is traveling toward the home. This is because when the route guidance is not being performed, the home is estimated to be the destination in the case where the vehicle is traveling toward the home and the destination is not estimated in the case where the vehicle is traveling to a place other than the home. When it is determined that the home is the destination, the motor traveling level EVL2 is set for the traveling section (i) (step S200), and when it is determined that the home is not the destination, the motor traveling level EVL of the traveling section (i) is set depending on the strength of the motor traveling that is set by the public institution or the like (step S210). The case where it is determined that the home is not the destination includes a case where the home is in the middle of the traveling route to the destination, that is, a case where the home is a passing place to the destination. In this case, the motor traveling level EVL of the traveling section (i) may be handled similarly to other vehicles, and therefore, the motor traveling level EVL of the traveling section (i) is set depending on the strength of the motor traveling that is set by the public institution or the like.

After the motor traveling level EVL of the traveling section (i) is set by one process of steps S180 to S210, it is determined whether the setting of the motor traveling level EVL for all traveling sections in the range of the acquired information has been ended (step S220). When it is determined that the setting of the motor traveling level EVL for all traveling sections has not been ended, the section variable i is incremented by a value “1”, and the hybrid ECU 50 returns to the process of reading the information about the traveling section (i) in step S140.

When it is determined in step S220 that the setting of the motor traveling level EVL for all traveling sections has been ended, the traveling assist plan is created using the set motor traveling level EVL (step S240). For example, the traveling assist plan can be created as follows. The motor traveling mode is assigned to each traveling section of the traveling route in the order from the traveling section that has the highest motor traveling level EVL. For the traveling section that has the motor traveling level EVL0, consumption energies E (n) in the traveling sections of the traveling route from the current place to the control end section (destination), and a total energy Esum that is the sum of the consumption energies E (n) are calculated. Consumption energies E (n) in traveling sections (traveling sections that do not have the motor traveling level EVL0) to which the motor traveling mode is assigned are subtracted from the total energy Esum, and thereby a total remaining energy Eevl0 that remains for the motor traveling level EVL0 is calculated. When the total remaining energy Eevl0 is equal to or smaller than the remaining charge amount of the battery 40, the CD mode is assigned to all traveling sections. When the total remaining energy Eevl0 is larger than the remaining charge amount of the battery 40, each traveling section that has the motor traveling level EVL0 is sorted in the order from the traveling section that has the lowest traveling load. The CD mode is assigned in the order from the traveling section that has the lowest traveling load, until the sum of the consumption energies En in the traveling sections to which the CD mode is assigned exceeds the remaining charge amount of the battery 40, and the CS mode is assigned to the other traveling sections.

Then, the traveling mode is controlled in accordance with the traveling assist plan (step S250), and it is determined whether a control end condition is satisfied (step S260). When it is determined that the control end condition is not satisfied, the hybrid ECU 50 returns to the process of determining whether the execution of the traveling assist control is possible in step S100. When it is determined that the control end condition is satisfied, the traveling assist control is ended.

In the embodiment, the map information, the current position of the own vehicle, and the route guidance are displayed on the display device 66, using the color depending on the motor traveling level EVL. FIG. 4 is an explanatory diagram showing an example in which the map information and the current position of the own vehicle are displayed using the hue, chroma and brightness (display method) depending on the motor traveling level EVL. In the figure, a region A1 is shown as a region for the motor traveling level EVL5 (LEZ (7)), using a relatively dark transparent blue, for example, and a region A2 is shown as a region for the motor traveling level EVL3 (LEZ (1) to LEZ (6)), using a relatively light transparent blue, for example. By such a display on the display device 66 using the hue, chroma and brightness (display method) depending on the motor traveling level EVL, it is possible to cause the user to easily recognize the motor traveling level EVL.

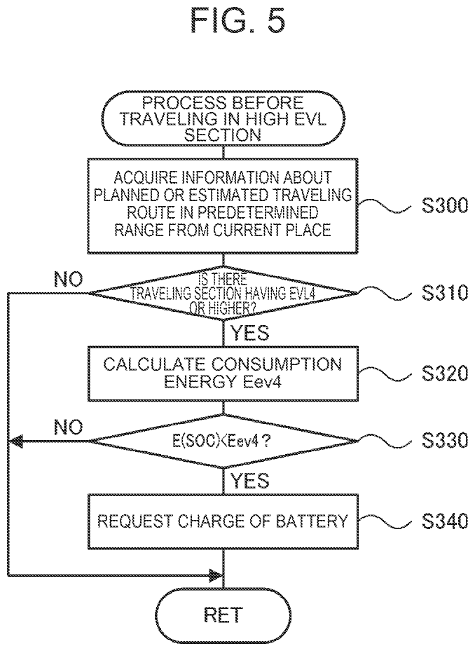

In the embodiment, when the hybrid electric vehicle 20 travels in the traveling section that has the motor traveling level EVLA or higher, a process (charge process) of increasing the state-of-charge SOC of the battery 40 is executed before the traveling in the traveling section that has the motor traveling level EVL4 or higher. FIG. 5 is a flowchart showing an example of a process that is executed by the hybrid ECU 50 before the traveling in a high motor traveling level section.

When the process before the traveling in a high motor traveling level section is executed, the hybrid ECU 50, first, acquires the information about the planned or estimated traveling route in the predetermined range from the current place (step S300), and determines whether the traveling route includes the traveling section that has the motor traveling level EVL4 or higher (step S310). When it is determined that the traveling route does not include the traveling section that has the motor traveling level EVL4 or higher, it is determined that the process is unnecessary, and the process is ended.

When it is determined in step S310 that the traveling route includes the traveling section that has the motor traveling level EVL4 or higher, a consumption energy Eev4 necessary to travel in the traveling section that has the motor traveling level EVL4 or higher is calculated (step S320). Then, it is determined whether the calculated consumption energy Eev4 is larger than a remaining energy E (SOC) of the battery 40 that is converted from the state-of-charge SOC of the battery 40 (step S330). That is, it is determined whether the remaining charge amount of the battery 40 allows the motor traveling to be performed in the traveling section that has the motor traveling level EVL4 or higher. When it is determined that the consumption energy Eev4 is equal to or smaller than the remaining energy E (SOC) of the battery 40, it is determined that the remaining charge amount of the battery 40 allows the motor traveling to be performed in the targeted traveling section and charging of the battery 40 is unnecessary, and the process is ended.

When it is determined in step S330 that the consumption energy Eev4 is larger than the remaining energy E (SOC) of the battery 40, the charging of the battery 40 is requested (step S340), and the process is ended. When the charging of the battery 40 is requested, the motor MG generates electric power using the dynamic power from the engine EG when the hybrid electric vehicle 20 reaches a predetermined distance (for example, 1 km or 2 km) before the traveling section that has the motor traveling level EVL4 or higher, and by the generated electric power, the battery 40 is charged. Thereby, it is possible to more accurately perform the motor traveling in the traveling section that has the motor traveling level EVL4 or higher.

The above-described hybrid electric vehicle 20 in the embodiment acquires the information about the planned or estimated traveling route in the predetermined range from the current place, creates the traveling assist plan by assigning the motor traveling mode in the order from the traveling section that has the highest motor traveling level EVL among the motor traveling levels EVL set for the traveling sections of the traveling route, and travels in accordance with the traveling assist plan. Thereby, it is possible to more accurately assign the motor traveling mode to the traveling section that has a high motor traveling level EVL, and to more accurately perform the motor traveling.

In the hybrid electric vehicle 20 in the embodiment, when there is the traveling section that has the motor traveling level EVL4 or higher, the process of increasing the state-of-charge SOC of the battery 40 is executed before the traveling in the traveling section that has the motor traveling level EVL4 or higher. Thereby, it is possible to more accurately perform the motor traveling in the traveling section that has the motor traveling level EVL4 or higher.

In the hybrid electric vehicle 20 in the embodiment, the motor traveling level EVL4 of the region where the motor traveling needs to be performed and that is set by the user is set so as to be higher than the mode traveling level EVL3 of the LEZ (1) to the LEZ (6) that are decided by the public institution. Thereby, it is possible to more accurately reflect the intention of the user.

In the hybrid electric vehicle 20 in the embodiment, when the spot set by the user as the home is planned or estimated to be the destination, the traveling assist plan is created such that the motor traveling mode is set preferentially to the traveling section to the home, and when the home is a passing spot to the destination, the traveling assist plan is created based on the motor traveling level of the traveling section that includes the home. Thereby, it is possible to more properly cope with the case where the user returns to the home and the case where the user passes through the home.

The correspondence relation between major elements of the embodiment and major elements of the disclosure described in SUMMARY will be described. In the embodiment, the engine EG corresponds to the “engine”, the motor MG corresponds to the “motor”, the battery 40 corresponds to the “electricity storage device”, and the hybrid electronic control unit 50 corresponds to the “control device”.

The correspondence relation between major elements of the embodiment and major elements of the disclosure described in SUMMARY does not limit elements of the disclosure described in SUMMARY, because the embodiment is an example for specifically describing a mode for carrying out the disclosure described in SUMMARY. That is, the disclosure described in SUMMARY should be interpreted based on the description in SUMMARY, and the embodiment is just a specific example of the disclosure described in SUMMARY.

The present disclosure has been described above with use of the embodiment. The present disclosure is not limited to the embodiment at all, and naturally, can be carried out as various modes without departing from the spirit of the present disclosure.

The present disclosure can be utilized in the hybrid electric vehicle manufacturing industry and the like.

What is claimed is:

1. A hybrid electric vehicle comprising:
an engine that is capable of outputting dynamic power for traveling;
a motor that is capable of outputting dynamic power for traveling;
an electricity storage device that is capable of exchanging electric power with the motor; and
a control device that executes a traveling assist control to travel based on a traveling assist plan, when the engine and the motor are controlled with switching between a motor traveling mode and an ordinary traveling mode, the motor traveling mode being a mode of performing motor traveling in which the hybrid electric vehicle travels by the dynamic power from the motor in a state where operation of the engine is stopped, the ordinary traveling mode being a mode of performing ordinary traveling in which the hybrid electric vehicle travels by the dynamic power from the engine and the dynamic power from the motor as necessary, the traveling assist plan being a plan in which the motor traveling mode or the ordinary traveling mode is assigned to each traveling section of a traveling route using information about each traveling section, the traveling route being planned or estimated based on map information and a position of the hybrid electric vehicle, wherein
the control device creates the traveling assist plan based on a motor traveling level set to each traveling section, the motor traveling level having a plurality of stages.

2. The hybrid electric vehicle according to claim 1, wherein the control device charges the electricity storage device before traveling in a traveling section in which the motor traveling level is a predetermined level or higher.

3. The hybrid electric vehicle according to claim 1, wherein the control device creates the traveling assist plan such that the motor traveling mode is set preferentially to a user setting traveling section that is set on the traveling route by a user as a section in which the motor traveling needs to be performed.

4. The hybrid electric vehicle according to claim 1, wherein the control device creates the traveling assist plan such that the motor traveling mode is set preferentially to an institution setting traveling section that is set on the traveling route by a public institution as a section in which the motor traveling needs to be performed.

5. The hybrid electric vehicle according to claim 4, wherein the control device creates the traveling assist plan such that the motor traveling mode is set preferentially to a section that is set at a predetermined strength or higher by the public institution as the institution setting traveling section in which the motor traveling needs to be performed, over a user setting traveling section.

6. The hybrid electric vehicle according to claim 1, wherein the control device creates the traveling assist plan such that the motor traveling mode is set preferentially to a traveling section to home, when a spot set by a user as the home is planned or estimated to be a destination, and creates the traveling assist plan based on the motor traveling level of a traveling section that includes the home, when the home is a passing spot to the destination.

7. The hybrid electric vehicle according to claim 1, comprising a display device that displays the position of the hybrid electric vehicle and at least a part of the traveling route together with the map information, wherein
the control device performs such a control that the display is performed on the display device by a display method based on the motor traveling level.
